(19) United States
(12) Patent Application Publication
(10) Pub. No.: US 2012/0284174 A1
(43) Pub. Date: Nov. 8, 2012

(54) METHOD FOR COMPLETING GIFT GIVING EXPERIENCE OF GIFTED FUNDS

(76) Inventors: Timothy Bentley, San Francisco, CA (US); Dillard Mills Baker, San Francisco, CA (US)

(21) Appl. No.: 13/101,012

(22) Filed: May 4, 2011

(51) Int. Cl. G06Q 40/00

(52) U.S. Cl. 705/39

(57) ABSTRACT

A method for completing gift giving experience of gift funds including receiving a signal for delivery of gift funds from a giver of a specified amount for use by a specified receiver; receiving gift conditions specified by the giver; notifying the receiver of the gift funds and the gift conditions; presenting a template message interface to the receiver, wherein an input field in the template message interface corresponds to gift condition; receiving confirmation of gift conditions satisfied by a purchase by the receiver through the composing of a purchase message; sending the purchase message with at least one indicator of the confirmation of the gift conditions, wherein the purchase message is composed through the template message interface by the receiver and sent to the giver; and transferring gift funds to the receiver upon sending the message and receiving confirmation of the gift conditions.

### TECHNICAL FIELD

This invention relates generally to the gift card field, and more specifically to a new and useful method for completing gift giving experience of gifted funds in the gift card field.

### BACKGROUND

Numerous companies and stores use gift cards as gift options for their customers. To the giver (the purchaser of the gift card) this has proven to be a convenient way to give a gift, and to allow the receiver (i.e., the recipient of the gift) to select the particular item from the store. However, by having the gift card tied to a particular store or chain of stores, a gift card sometimes becomes a burden to the receiver. The receiver sometimes has to go out of their way to visit a particular store, and then is limited to the items available in that particular store. The actual gift of a gift card may also appear impersonal as the receiver can get whatever item they want from the store. This may lead to the receiver purchasing items that are uncharacteristic of the intentions of the giver. For example, the item purchased with the gift card may carry no emotional attachment such as using the gift card for household necessities or common day expenses. Thus, giving a gift card is often viewed as less personal than a physical gift. Furthermore, a giver has neither any idea how the gift card is spent nor any control over what that item may be. Thus, there is a need in the gift card field to create a new and useful method for completing the gift giving experience of gifted funds. This invention provides such a new and useful method.

### SUMMARY OF THE INVENTION

A method of the preferred embodiment preferably includes a giver providing gift funds and setting conditions within a gift system, and the gift system enforcing those conditions through the requirement of a purchase message that is sent to the giver with information of how the gift funds have been used. The method functions to create a gift giving feedback loop through added conditions and messaging. The method is preferably incorporated into a web service and may additionally utilize mobile computing devices for near, point-of-sale redemption of gift funds by a receiver. The method of the preferred embodiment was developed through testing and experimentation with web service powered gift cards. The first insight came by identifying that the traditional gift card experience, which is ubiquitous in the present day, is deeply flawed in the experience it creates for the participants (i.e., the giver and the receiver). It was discovered that traditional gift cards minimize the amount of friction of gift giving (i.e., how easy it is to give a gift card) beyond a level required for an enjoyable experience. The method of the preferred embodiment incorporates additional points of friction that un-intuitively improves the gift-giving experience for the giver and receiver. During testing, a thank you note was identified to lead to a more enjoyable experience for a giver. The method of the preferred embodiment enforces a thank you card (i.e., purchase message) to be sent as a restriction to transferring funds to the receiver. The purchase message is an additional task (that adds “friction” to the system), but that functions to complete the gift giving feedback loop for the giver (and ultimately increases the experience for both the giver and the receiver).

Another aspect of the preferred method incorporates conditions specified by the giver. Traditional gift cards are cards with a set amount of money typically only usable in a specific store. While these do sometimes limit purchases of the receiver to a group of stores, the traditional gift card does not place conditions on what is purchased within that set ecosystem. For example, a gift card to large department store has no capability to limit purchases to a particular type of item in that department store. Through experimentation, an insight for the invention revealed that giver specified conditions made the gift giving experience more enjoyable. From a giver point of view, specific conditions for the gift funds provide a more personal touch than money restricted to a particular store. From the receiver point of view, the gift purchase had to raise to the level of being worthy of satisfying the gift conditions when gift conditions were coupled to a purchase message. This consequently increased the satisfaction in the purchases by the receivers. Thus the method of the preferred embodiment preferably incorporates conditions set by the giver and a purchase message that includes at least one indicator that conditions are satisfied. The coupling of these new steps is highly unintuitive, since the system introduces additional friction to the gift giving experience. In development of the invention, the method placed more significance in how the gift funds were used by the receivers. In testing, receivers were discovered to place careful consideration to what purchase was selected for use with the gift funds. As a comparative example, with traditional gift cards, a receiver was found to more frequently spend the money on common day necessities before the card was lost or forgotten. The invention additionally has other unique benefits that prior gift card implementations lack. For example, the condition-based approach alters the business owners role; businesses now have an incentive to offer special offers and deals for receivers looking to make a purchase with the gift funds. The new and useful method of the preferred embodiment drastically alters the gift giving experience, which benefits the giver and the receiver.

As an exemplary scenario of the method in use, a giver may decide to give a friend a $50 dollar meal. Within a web interface, the giver inputs credit card information for charging $50 from their account. The giver also fills out a condition input field specifying that the $50 is for a dinner for the friend and the spouse of the friend. The funds are transferred to the gift system and held until the friend confirms conditions are satisfied and sends a thank you note. The friend receives notification of the gift from the giver. The friend plans a dinner with his spouse to use the gift. At the dinner the friend opens an application of the gift system on his phone. The app allows him to add a photo of him and his spouse at the dinner, write a quick message thanking his friend for the gift and send the message. The conditions having been satisfied (as implicitly indicated by the receiver in writing the message) and the message having been sent, the gift system releases the held gift funds for access by the receiver.

### BRIEF DESCRIPTION OF THE FIGURES

FIGS. 1 and 2 are schematic representation of a method and system, respectively, of a preferred embodiment;

FIG. 3 is an exemplary representation of an interface for setting gift funds and conditions of a preferred embodiment;

FIG. 4 is a detailed schematic representation of a variation where a composed purchase message enables automatic sending of the purchase message and gift funds transfer upon identifying a corresponding transaction of a preferred embodiment; and

FIG. 5 is an exemplary representation of an interface for template purchase message of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

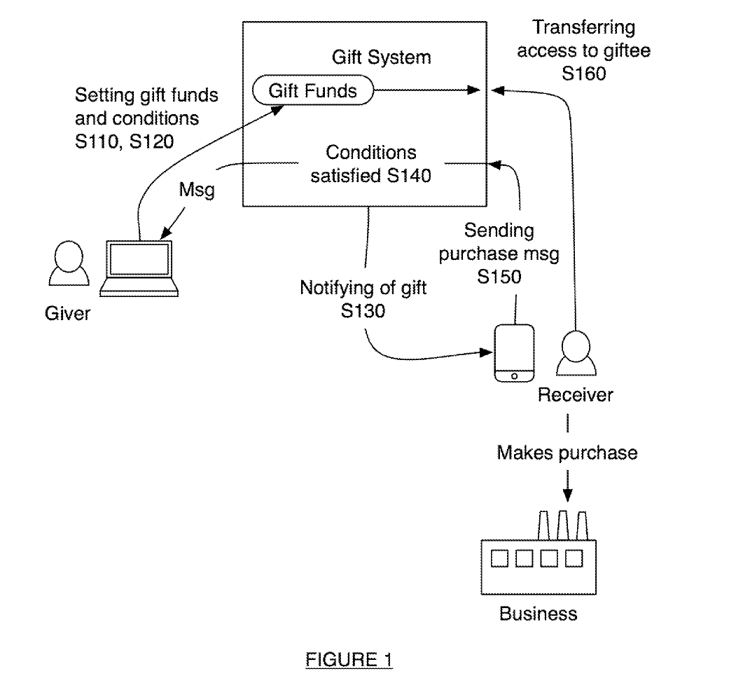

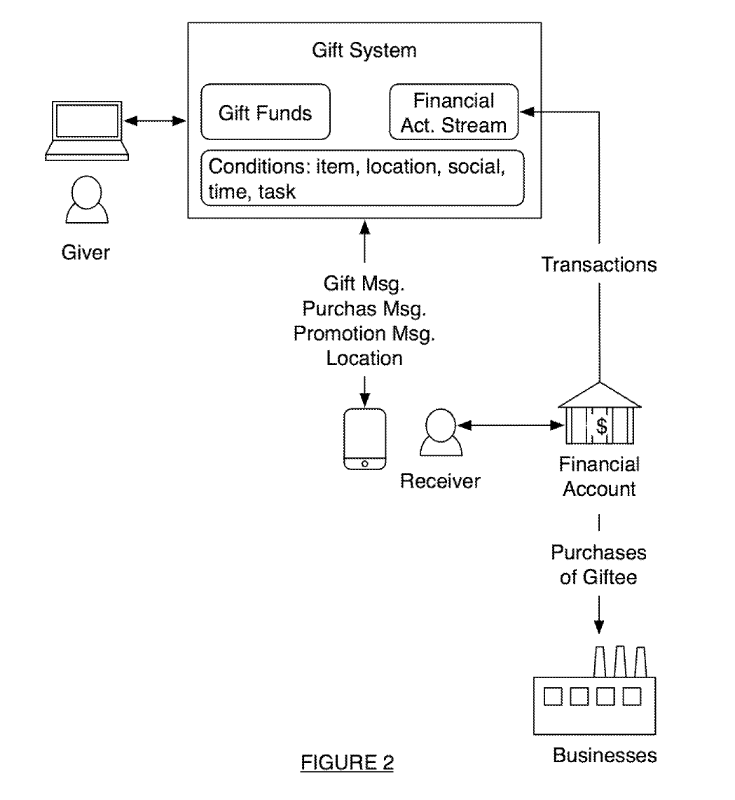

As shown in FIG. 1, a method of a preferred embodiment includes receiving a signal for delivery of gift funds of a specified amount from a giver to a receiver S110, receiving gift conditions of the gift funds specified by the giver S120, notifying the receiver of the gift funds and the gift conditions S130, receiving confirmation of gift conditions satisfied by a purchase by the receiver S140, sending a purchase message with at least one indicator of the confirmation of the gift conditions S150, and transferring gift funds provided by the giver to the receiver upon sending the purchase message S160. The method functions to create a more interactive gift giving experience. The method preferably creates a more satisfying experience for the giver by enabling a giver to give more personal gifts and creating a feedback loop so the giver sees the results of the gift. The receiver similarly has more freedom in selecting a gift and may additionally benefit from company offers resulting from use of this method. As shown in FIG. 2, the method is preferably implemented through a gift system which is preferably a web service managing the communication and processing of actions of the receiver and giver. The gift system is preferably a server or servers hosted on a distributed computing infrastructure, but any suitable hosting platform may alternatively be used. The gift system may additionally communicate over mobile computing device applications and/or web interfaces for interfacing with users and businesses. In some variations, physical totems may even facilitate completion of the method. In some variations, the method includes gift conditions that are automatically verified during purchasing steps. Yet, in other variations, a purchase message (e.g., a thank you note) preferably acts as the trigger for a receiver receiving access to the gift funds.

Step S110, which includes a signal for delivery of gift funds of a specified amount from a giver to a receiver, functions to create a gift exchange session within the gift system for the specified amount. Preferably, the giver provides the funds when signaling the gift funds, which may include receiving credit card, bank account, check, cash, or any suitable form of monetary currency in exchange for buying gift funds for the receiver. Alternatively, the funds may not be transferred away from the giver until after the receiver has satisfied the conditions to be eligible for gift funds. In this alternative, the giver pays for the gift after the receiver has completed a purchase, and then the receiver is reimbursed. The gift funds preferably have a set cash value. Alternatively, with particular conditions, the gift may be reoccurring. For example, a gift for $20 every month for coffee and drinks. The gift funds are preferably specified by the giver, but alternatively, the giver selects from fixed amounts such as $20, $50, and $100 gifts. Several givers may additionally contribute to the gift fund. For example, several friends may pool together to give a large gift to a friend. The signal for delivery of gift funds is preferably received at the gift system through a web or application interface.

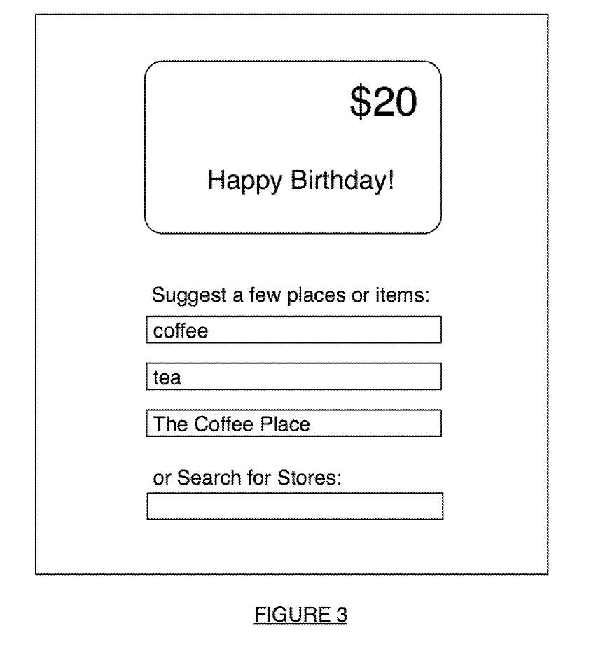

Step S120, which includes receiving gift conditions of the gift funds specified by the giver, functions to collect information on the limitations and restrictions for the purchase by the receiver. Preferably, the conditions are satisfied by the receiver and then the receiver is able to access the gift funds. Some variations tightly enforce the conditions, such as monitoring transactions and location of purchase. Alternative variations may enable receiver interpretation of the conditions and may rely on the purchase message sent to the giver as an implicit confirmation the conditions were satisfied. There are various types of gift conditions that may be placed on the gift. Conditions may be added, removed, and edited preferably by the giver. Some cards may come with pre-configured conditions, which can preferably be modified by the giver. While other cards may require specification by the giver. Similarly, previously configured gift conditions (made by other users) may be shared and selected for use by a giver. Preferably, the type of gift is a type of condition. The type of gift may be a specific product, a category of purchase, an eligible store or any suitable description on the item purchased. As shown in FIG. 3, a user may additionally be able to specify multiple descriptions of eligible purchases. A condition may be location based. The location condition may be a physical location such as what city the purchase should be made, but may alternatively be type of location such as sporting goods store or restaurant. The condition may be a social condition that may include specifying additional participants involved in the purchase (and such conditions may require social verification as described below). For example, a condition may be for a dinner to involve the receiver with his or her spouse. The condition may be time based such as a valid window for use or, as described above, a reoccurring limit with reoccurring gift funds. For example, the purchase may be required to occur on the birthday of the receiver. The condition may alternatively be task based. For example, the condition may involve a dare (e.g., drink a jar of pickle juice) or a list of tasks. The conditions can additionally be combined. For example, eating three ice-cream cones in three different locations in one day would be a combination of item, tasks, location, and time conditions.

The giver preferably sets the conditions when selecting the amount of gift funds. An interface is preferably provided for creating itemized conditions, which may aid in the automatic verification of the condition and/or in prompting a receiver to use gift funds for a past purchase. The interface is preferably a web interface but may alternatively be an interface for a desktop application, mobile application, game system, kiosk or for any suitable computing device. For example, a list of items are preferably available for adding to the conditions field. Suggestions may additionally be supplied through history information of the receiver. The gift redemption history, social media profile, or any suitable information of the receiver may be used to suggest gifts. Alternatively, the conditions may be a required text field in which the giver can write any suitable description. In this variation, the gift system preferably relies on self-monitoring of the conditions as facilitated by making the receiver compose the purchase message. Alternatively, particular condition parameters may be generated through natural language processing of the condition description. After specifying the conditions and the gift funds the giver preferably submits a form that is preferably communicated to the gift system.

Step S130, which includes notifying the receiver of the gift funds and the gift conditions, functions to communicate to the receiver that the giver has given them a gift. The notification is preferably delivered over email, but may alternatively be delivered through an app, social media platform, in text message, or through any suitable communication method. The delivery address of the receiver is preferably provided by the giver while selecting gift fund amounts and the conditions. The receiver is preferably notified of the amount of the gift and the conditions of the gift. The giver or givers are also preferably listed, but may alternatively be anonymous. In one variation, a receiver may be enabled to merge gifts. The gift funds and the gift conditions may additionally be combined with previously received gift funds. Additionally, as a receiver uses the gift funds, the balance can preferably be checked and alternatively adjusted (e.g, merged) according to receiver instructions.

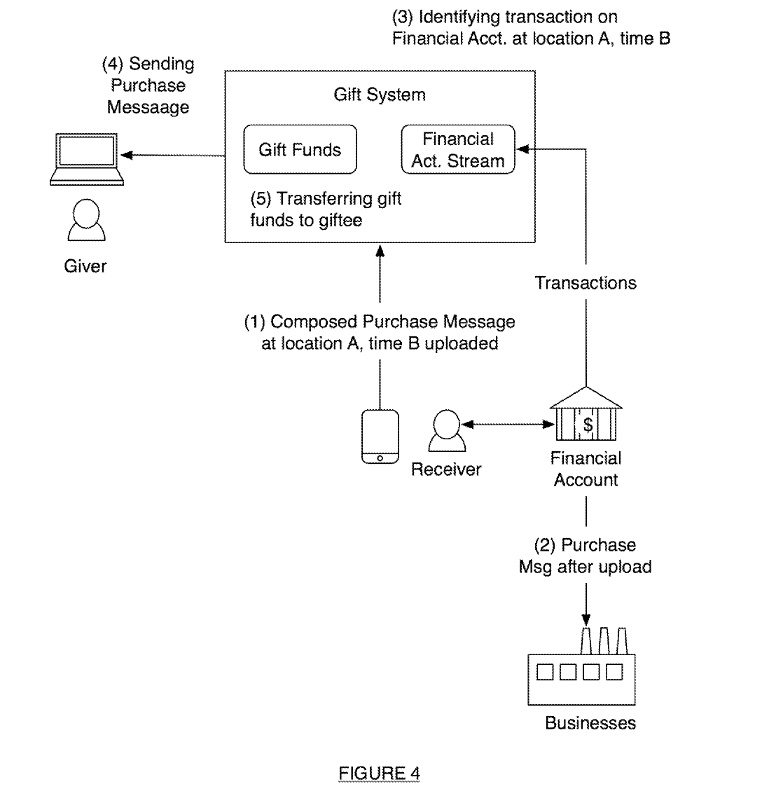

Step S140, which includes receiving confirmation of gift conditions that are satisfied by a purchase by the receiver, functions to check for explicit or implicit satisfaction of the gift conditions. Preferably the purchase message sent in Step S150 serves as an implicit confirmation. The purchase message preferably includes information about the purchase such as the item purchased, where and when the purchased occurred, and any other suitable details about the purchase. The act of sending the purchase message can preferably be interpreted as the receiver declaring to the giver that the purchase satisfies the conditions set by the giver. There may be cases when the purchase does not match the conditions specified by the giver, but in informing the giver of what was purchased, the receiver is signaling to the gift system that the purchase satisfies the conditions based on the personal relationship between the giver and the receiver. Alternatively, automatic confirmation of conditions may be employed. One version includes receiving financial account information from the receiver, monitoring transactions of the financial account, identifying transactions that satisfy gift conditions, and presenting transactions for selection by the receiver. These sub-steps function to automatically identify purchases that may satisfy the conditions. The financial account is preferably a credit card account, but may alternatively be a checking account, debit card, or any suitable financial account. In a variation, the receiver is allowed to determine if and which purchase to use with the gift funds. For example, a purchase may qualify but the receiver may not have intended that purchase to be used with the gift funds. In another variation, after automatically identifying a purchase, steps S150 and S160 are automatically triggered. Additionally, the financial account is preferably monitored in substantially real-time and a qualifying purchase is preferably identified within an hour and more preferably within a few minutes. A notification can be sent to the receiver when a qualifying purchase is identified in real-time, prompting the receiver to use the gift funds for that purchase. A qualifying purchase is preferably identified by matching the item, location, and/or time conditions with the time and store of the purchase. The stores are preferably assigned various attributes that correspond to types of places or particular products. For example, if a condition includes buying a book, a purchase made at bookstore could qualify. In similar variation, the receiver is preferably required to compose a purchase message prior to purchase as shown in FIG. 4. The message is preferably composed within 30 minutes of purchasing, but any suitable time limit may be used. The composed purchase message is then uploaded to the gift system, and the next transaction of the financial account that corresponds to the purchase message triggers Steps S150 and S160. Preferably, transactions are identified by matching the time and location of the composed message with the time and location of a transaction. This variation preferably enables the receiver to unlock redemption of the gift funds by composing a purchase message prior to paying for the item.

Depending on the type of condition, various techniques may be used to confirm them. A picture, video or any suitable form of multimedia is one form of confirmation. In some variations, a picture or video must capture what was purchased. The picture or video is preferably sent to the giver. This can act as an implicit form of confirmation because the act of showing the giver what was purchased is a way that the receiver can show the giver that the conditions were satisfied. Mere social pressure would prevent most people from sending a picture of a newly purchased gaming console, when the giver had specified a new sofa bed. Location at the time of purchase is another technique to confirm a condition. The location is preferably obtained through GPS, financial transaction information, geotagging of images, or any suitable location services provided from a mobile computing device of the receiver. A receiver is preferably required to send a purchase message at the time of purchase, which causes the receiver to open an application such that location of the purchase can be obtained. The location can be linked to what store the purchased occurred, as well as what sorts of items are sold in that store. The gift system preferably includes a database that includes a mapping of locations to types of items available for purchase at those locations. Similarly, participating locations can display various forms of totems, which may be a code or an object. The receiver is preferably required to answer a question about the totem to prove they were at that location. For a social condition, at least one outside person that is part of the social condition may be contacted. For example, if the condition was to purchase an item with a particular friend, then that friend may be sent a message to which the friend can confirm or deny that the purchased happened. Time conditions may be satisfied by analysis of the time of the purchase as indicated in a financial account, time stamp of a photo, time of access of a mobile application during the purchase, time of sending the purchase message, or through any suitable time.

Additionally, businesses that may satisfy conditions of the gift may send notifications to the receiver. This functions to allow incentivized businesses to acquire the business of the receiver. Since the gift funds are allowed to be used at any business where the conditions are satisfied, business may provide special offers for receivers. Additionally, based on the location of a receiver, nearby businesses may be enabled to push a notification to a mobile device of the receiver informing the receiver of the special offer. The businesses that can notify the receiver preferably satisfy the conditions set by the giver, and thus purchases using the offers preferably pre-confirmed to satisfy the conditions. Redeeming the offer will preferably use the gift for that purchase. The offer may be redeemed through an in application action, inputting a code, or through any suitable redemption technique.

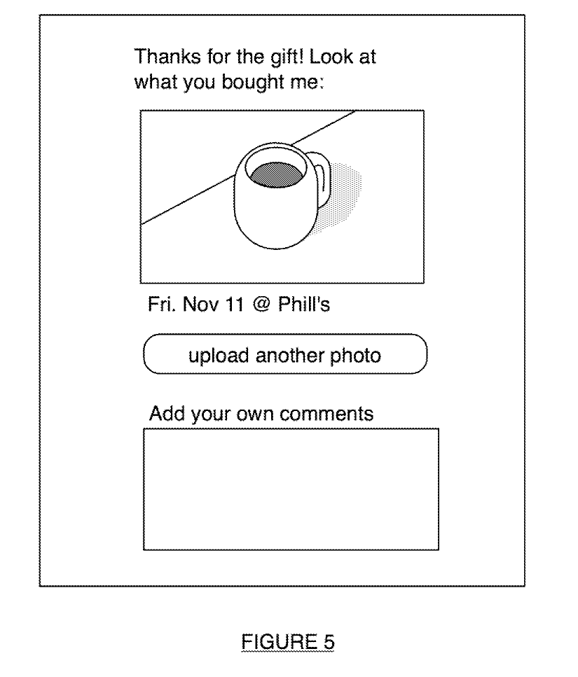

Step S150, which includes sending a purchase message with at least one indicator of the confirmation of the gift conditions, functions to inform the giver of the purchase made by the receiver. The purchase message preferably takes form as a thank you note from the receiver. The purchase message is preferably an email or social network message, but may alternatively be a text message, a post card, paper letter, or any suitable deliverable message. In one variation, the purchase information (e.g., what was purchased) and/or the purchase message is shared through a social media channel. The purchase message preferably includes input fields that require input from the receiver. A template message interface is preferably presented to the receiver, as shown in FIG. 5. The template message interface may have several fields that are required to be filled, and—by filling in the fields—a full message is composed. For example, there may be several blank text fields in between a generic thank you message, and the text fields are for the item purchased and the location of the purchase. These fields may correspond to different conditions set by the giver. The template message interface is preferably presented on a web application or in a mobile device application. Fields may automatically be filled, such as the location of the purchase. Additionally, a picture or video may be a required or optional component of the purchase message. The purchase message may alternatively be completely composed by the receiver or automatically generated by the gift system. In some variations, a purchase message cannot be sent until automatically verified conditions are satisfied. The receiver may need to provide additional information if some conditions are not automatically detected. In the preferred embodiment, composing and sending the purchase message implicitly satisfies the conditions.

Step S160, which includes transferring gift funds provided by the giver to the receiver upon sending the purchase message, functions to reimburse the receiver with the gift funds provided by the giver. The receiver preferably makes a purchase with his or her own money. The gift funds are preferably accessible by the receiver after conditions have been confirmed and the purchase message has been sent. The gift funds are preferably held by the gift system and thus are made accessible upon satisfying the purchase message sending requirement and/or gift conditions. Alternatively, the gift system holds financial account records of the giver and only charges the giver when the gift funds may be immediately transferred to the receiver. The funds are preferably delivered to a financial account of the receiver. Alternatively, the funds are retained within the gift system, and are available for contribution to gift funds for a second receiver or for delivering to a financial account of the receiver. For example after a first receiver is granted access to the gift funds, the first receiver may decide to not give the gift system their financial account information. This preferably keeps the gift funds within the gift system. These funds however are preferably still available for the first receiver to give a gift to a second receiver (where the first receiver is a second giver).

An alternative embodiment preferably implements the above methods in a computer-readable medium storing computer-readable instructions. The instructions are preferably executed by computer-executable components preferably integrated with a gift system that is hosted on a distributed platform. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for completing gift giving experience of gift funds comprising:
receiving a signal for delivery of gift funds from a giver of a specified amount for use by a specified receiver;
receiving gift conditions specified by the giver;
notifying the receiver of the gift funds and the gift conditions;
presenting a template message interface to the receiver, wherein an input field in the template message interface corresponds to gift condition;
receiving confirmation of gift conditions satisfied by a purchase by the receiver through the composing of a purchase message;
sending the purchase message with at least one indicator of the confirmation of the gift conditions, wherein the purchase message is composed through the template message interface by the receiver and sent to the giver; and
transferring gift funds to the receiver upon sending the message and receiving confirmation of the gift conditions.

2. The method of claim 1, wherein the at least one indicator of the confirmation of the gift conditions is a description of the purchase by the receiver.

3. The method of claim 1, wherein receiving confirmation of gift conditions includes receiving a send message command from the receiver; wherein the sent message serves as confirmation of gift conditions.

4. The method of claim 1, wherein a field of the template message interface is automatically completed.

5. The method of claim 4, wherein the template message interface is presented on a mobile computing device; and further including detecting location at time of purchase by the receiver and automatically adding detected location to the input field of the template message interface.

6. The method of claim 1, wherein a classification of the type of purchase is a condition set by the receiver, wherein confirming the type of purchase gift condition includes matching the location of the purchase with the type of purchase using a database pairing locations and purchase classifications.

7. The method of claim 1, wherein at least one condition is a social-based condition that specifies at least one participant in addition to the receiver to be involved in the purchase of the receiver, and wherein receiving confirmation of gift conditions includes verifying presence of the at least one participant during the purchase.

8. A method for completing a gift giving experience with gift funds comprising:
receiving a signal for delivery of gift funds from a giver of a specified amount for use by a specified receiver;
receiving gift conditions specified by the giver;
notifying the receiver of the gift funds and the gift conditions; wherein the notification is communicated to a mobile device application from a gift system;
the mobile device application, confirming gift conditions during a purchase by the receiver;
sending a purchase message from the mobile device application to the giver with at least one indicator of the confirmation of the gift conditions; and
transferring gift funds to the receiver upon sending the message.

9. The method of claim 8, wherein a template message interface is presented on a mobile computing device with at least one input field corresponding to a gift condition; and further including detecting location at time of purchase by the receiver through a geolocation service of the mobile computing device; and automatically adding the detected location to the input field of the template message interface.

10. The method of claim 8 wherein confirming gift conditions includes capturing multimedia through the mobile device application of the item purchased.

11. The method of claim 10, wherein confirming gift conditions further includes detecting location occurs during the capture of multimedia; and automatically adding the detected location to the input field of the template message interface.

12. The method of claim 1, further comprising receiving financial account information from the receiver; and wherein confirming the gift conditions includes receiving a composed purchase message prior to purchase by the receiver; monitoring transactions of the financial account; identifying a transaction that corresponds to the composed purchase message; and wherein the gift funds are transferred to the receiver and the purchase message automatically sent upon identifying the transaction.

13. The method of claim 12, wherein location information is included in the composed purchase message and wherein identifying the transaction that corresponds includes comparing location of transaction to location in the purchase message.

14. The method of claim 8; further comprising detecting location of receiver through a geolocation service of the mobile computing device; determining if a qualifying location is in the vicinity, sending a message of the qualifying location to the user.

15. A method for completing gift experience for gift funds comprising:
receiving a signal for delivery of gift funds from a giver of a specified amount for use by a specified receiver;
receiving gift conditions specified by the giver;
notifying the receiver of the gift funds and the gift conditions;
receiving confirmation of gift conditions satisfied by a purchase by the receiver;
sending message with at least one indicator of the confirmation of the gift conditions, the message initiated by the receiver and sent to the giver; and
transferring gift funds to the receiver upon sending the message.

16. The method of claim 15, further comprising receiving financial account information from receiver; monitoring transactions in financial account; identifying transactions that satisfy gift conditions; and notifying receiver of identified transactions; wherein receiving confirmation of gift conditions is achieved through selection by the receiver of one of the identified transactions.

17. The method of claim 16, wherein a transaction is identified as satisfying gift conditions substantially in real-time; and pushing a notification to a mobile device of the receiver.

18. The method of claim 15, wherein transferring gift funds includes presenting an option to transfer funds to a financial account of the receiver and an option to use the gift funds for a second receiver.

19. The method of claim 15, wherein at least a second giver contributes to the gift funds.

20. The method of claim 15, further comprising providing option for the giver to accept or deny transfer of gift funds based on the sent purchase message; wherein transferring of gift funds occurs after the giver accepts transfer of gift funds.
